(19) United States
(12) Patent Application Publication
(10) Pub. No.: US 2010/0038077 A1
(43) Pub. Date: Feb. 18, 2010

(54) Method for Centralized Proppant Storage and Metering

(76) Inventors: Paul W. Heilman, Duncan, OK (US); Herbert John Horinek, Duncan, OK (US); Lloyd McNeel, Rock Springs, WY (US)

Correspondence Address: JOHN W. WUSTENBERG, P.O. BOX 1431, DUNCAN, OK, 73536, US

(21) Appl. No.: 12/604,871

(22) Filed: Oct. 23, 2009

Related U.S. Application Data
(62) Division of application No. 11/363,559, filed on Feb. 27, 2006.

(51) Int. Cl. E21B 47/00; E21B 43/16; G06F 17/00

(52) U.S. Cl. 166/250.01; 166/305.1; 705/400

(57) ABSTRACT

Methods for manufacturing well treatment fluid including delivering to a blending unit a desired rate of proppant by weighing a proppant storage and metering unit storing the proppant; and adjusting the size of a calibrated aperture on the proppant storage and metering unit. Methods also include delivering chemicals from a chemical storage and metering unit to the blending unit; combining the proppant and chemicals in the blending unit; and allowing the well treatment fluid to flow from the blending unit to a well location.

### CROSS-REFERENCE TO RELATED APPLICATIONS

This application is a divisional of U.S. patent application Ser. No. 11/363,559 filed Feb. 27, 2006, which is hereby incorporated by reference it its entirety.

### FIELD OF THE INVENTION

The present invention relates generally to well operations, and more particularly to methods and apparatuses for manufacturing well treatment fluid so as to conserve labor, infrastructure, and environmental impact.

### BACKGROUND

In the production of oil and gas in the field, it is often required to stimulate and treat several well locations within a designated amount of time. Stimulation and treatment processes often involve mobile equipment that is set up and put in place at a pad and then moved by truck from pad to pad within short time periods. Only during non-stimulation activities, such as water flood operations, can some operations occur simultaneously.

This movement of equipment and personnel can involve complex logistics. The servicing and stimulation of wells can require a series of coordinated operations that begin with the supply by truck of equipment, supplies, fuel, and chemicals to the wellhead. The equipment is then set up and made ready with proppant and chemicals. After completion of the well services, equipment must be broken down and made ready for transport to the next pad for service. Often, the next pad will be less than 500 feet away from the previously treated pad. In addition, due to the limited storage capacity of the moving equipment for chemicals and equipment, additional trucks are often required to resupply and reequip an existing operation. This movement of equipment and supplies has environmental impacts, and the exposure of mobile equipment to adverse weather conditions can jeopardize well treatment operations and worker safety.

### SUMMARY

In general, an apparatus for manufacturing well treatment fluid is disclosed. The apparatus includes a proppant storage and metering unit, a chemical storage and metering unit connected to a blending unit, and an electronic control system connected to the proppant storage and metering unit, the chemical storage and metering unit, and the blending unit, wherein the proppant storage and metering unit, chemical storage and metering unit, and blending unit are contained in a single land based enclosure. The proppant storage and metering unit and the chemical storage and metering unit are arranged around the blending unit. The apparatus also includes a pre-gel blending unit. The proppant storage and metering unit contains a controlled orifice. The chemical storage and metering unit contains flow meters. The electronic control system can automatically control the proppant storage and metering unit, chemical storage and metering unit, and blending mixer. The electronic control system can remotely control the proppant storage and metering unit, chemical storage and metering unit, and blending mixer. The electronic control system can automatically control the proppant storage and metering unit, chemical storage and metering unit, pre-gel blending unit, and blending mixer. The electronic control system can remotely control the proppant storage and metering unit, chemical storage and metering unit, pre-gel blending unit, and blending mixer. The proppant storage and metering unit, the chemical storage and metering unit, the blending unit, and the enclosure include convective, conductive, or radiant heaters. The enclosure can be climate controlled. The enclosure and proppant storage and metering unit comprise air ventilators and air filters. The proppant storage and metering unit can deliver proppant to the blending unit using substantially gravity. The enclosure is a structure selected from the group consisting of a supported fabric structure, a collapsible structure, a prefabricated structure, a retractable structure, a composite structure, a temporary structure, a prefabricated wall and roof structure, a deployable structure, a modular structure, a preformed structure, a mobile accommodation structure, and combinations thereof. The proppant storage and metering unit is connected to a pneumatic refill line. The proppant storage and metering unit can be filled with proppant using the pneumatic refill line while contained in the enclosure. The proppant storage and metering unit includes adjustable, calibrated apertures. The proppant storage and metering unit, the chemical storage and metering unit, and the blending unit are modular. The pre-gel blending unit is modular. The proppant storage and metering unit is connected to a surge hopper with an adjustable, calibrated aperture. The proppant storage and metering unit, chemical storage and metering unit, and blending unit can be substantially powered by electricity. The apparatus further contains a second blending unit connected to the chemical storage and metering unit and proppant storage and metering unit. The chemical storage and metering unit includes positive displacement variable speed pumps. The proppant storage and metering unit and the chemical storage and metering unit can include weight sensors.

In one embodiment, a method for manufacturing well treatment fluid is disclosed. The method includes delivering to a blending unit a desired rate of proppant by weighing a proppant storage and metering unit storing the proppant, and adjusting the size of a calibrated aperture on the proppant storage and metering unit, delivering chemicals from a chemical storage and metering unit to the blending unit, and combining the proppant and chemicals in the blending unit. The proppant can be delivered from the proppant storage and metering unit to the blending unit using substantially gravity. The method also includes delivering chemicals from a pre-gel blending unit to the blending unit.

In one embodiment, a method for manufacturing well treatment fluid is disclosed. The method includes delivering to a blending unit a desired rate of proppant by: delivering proppant from a proppant storage and metering unit to a surge hopper, maintaining a fixed level of proppant in a surge hopper, and adjusting the size of a calibrated aperture on the surge hopper, delivering chemicals from a chemical storage and metering unit to the blending unit, and combining the proppant and chemicals in the blending unit. The proppant is delivered from the proppant storage and metering unit to the surge hopper using substantially gravity. The method also includes delivering chemicals from a pre-gel blending unit to the blending unit.

In one embodiment, a method for manufacturing well treatment fluid at a single location is disclosed. The method includes delivering to a first blending unit components of a first desired composition of a first well treatment fluid, blending the components in the first blending unit to create the first well treatment fluid having the first desired composition, substantially simultaneously delivering to a second blending unit components of a second desired composition of a second well treatment fluid, and blending the components in the second blending unit to create the second well treatment fluid having the second desired composition. The first well treatment fluid includes a compound selected from the group consisting of proppant, liquid additives, dry additives, fluid modifiers, and combinations thereof. The second well treatment fluid includes a compound selected from the group consisting of proppant, liquid additives, dry additives, fluid modifiers, and combinations thereof. The method also includes substantially simultaneously monitoring a quantity of the components delivered to the blending unit.

In one embodiment, a method for determining the usage of dry components during the manufacture of well treatment fluid is disclosed. The method includes delivering dry components to a blending unit, and substantially simultaneously measuring the quantity of dry components delivered to the blending unit. The dry components include a compound selected from the group consisting of proppant, dry additives, dry fluid modifiers, and combinations thereof.

In one embodiment, a method for determining the usage of dry components during the manufacture of well treatment fluid is disclosed. The method includes delivering dry components to a blending unit, and substantially simultaneously measuring the quantity of dry components remaining. The dry components include a compound selected from the group consisting of proppant, dry additives, dry fluid modifiers, and combinations thereof.

In one embodiment, a method for determining the usage of well treatment fluid components during the manufacture of well treatment fluid is disclosed. The method includes delivering a component of a well treatment fluid to a blending unit, and substantially simultaneously weighing the container storing the component. The component includes a compound selected from the group consisting of proppant, liquid additives, dry additives, fluid modifiers, and combinations thereof.

In one embodiment, a method for billing for well stimulation services is disclosed. The method includes substantially simultaneously with the completion of a well stimulation treatment, relating the quantity of a well treatment component delivered to a well with a cost schedule to determine the cost of the component.

### BRIEF DESCRIPTION OF THE DRAWINGS

A more complete understanding of the present disclosure and advantages thereof may be acquired by referring to the following description taken in conjunction with the accompanying drawings. The drawings illustrate only exemplary embodiments and are not intended to be limiting against the invention.

FIG. 1 is a diagram of a centralized well treatment facility.

FIG. 2 is a flow diagram of a centralized well treatment facility.

FIG. 3 is a flow diagram of central manifold used to treat wells and recover production fluid.

FIG. 4 is a diagram of a multiple manifold well treatment system.

FIG. 5 is a schematic of a manifold apparatus for directing treatment fluid.

FIG. 6 is a schematic of a manifold apparatus for directing treatment fluid.

FIG. 7 is a schematic of a simultaneous fracturing method.

FIG. 8 is a schematic of a cross section of the well treatment facility.

### DETAILED DESCRIPTION

The details of the methods and apparatuses according to the present invention will now be described with reference to the accompanying drawings.

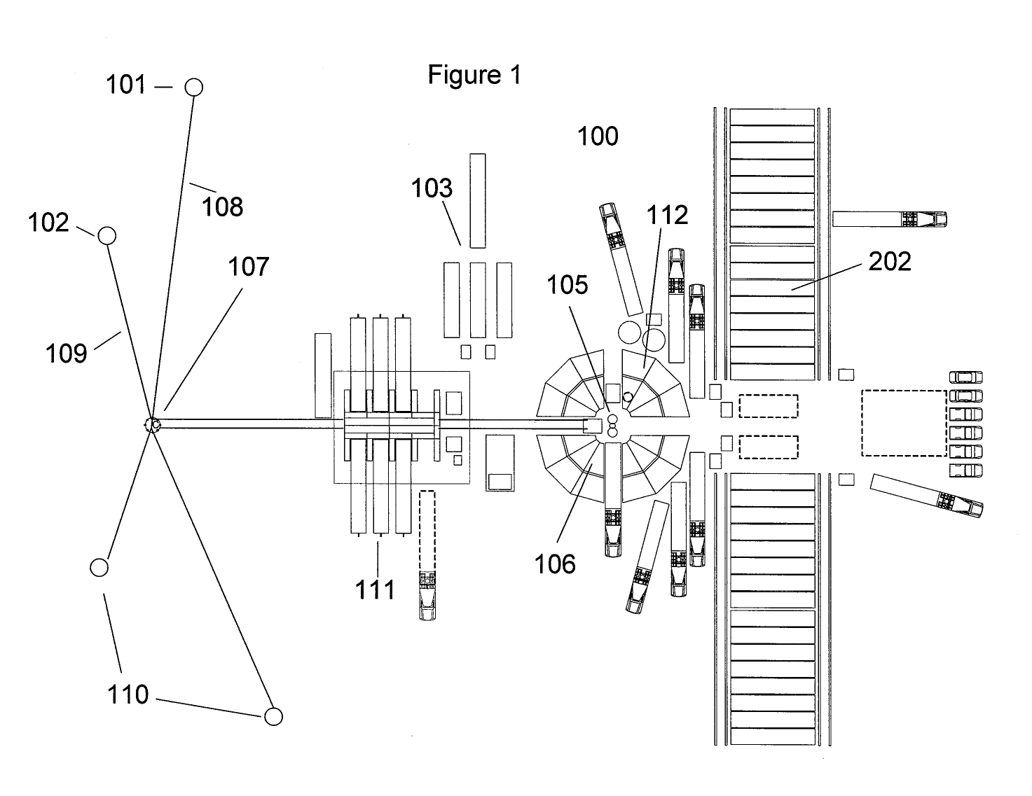

In reference to FIG. 1, in one embodiment, a well treatment operations factory 100 includes one or more of the following: a centralized power unit 103; a pumping grid 111; a central manifold 107; a proppant storage system 106; a chemical storage system 112; and a blending unit 105. In this and other embodiments, the well treatment factory may be set upon a pad from which many other wellheads on other pads 110 may be serviced. The well treatment operations factory may be connected via the central manifold 107 to at least a first pad 101 containing one or more wellheads via a first connection 108 and at least a second pad 102 containing one or more wellheads via a second connection 109. The connection may be a standard piping or tubing known to one of ordinary skill in the art. The factory may be open, or it may be enclosed at its location in various combinations of structures including a supported fabric structure, a collapsible structure, a prefabricated structure, a retractable structure, a composite structure, a temporary building, a prefabricated wall and roof unit, a deployable structure, a modular structure, a preformed structure, or a mobile accommodation unit. The factory may be circular and may incorporate alleyways for maintenance access and process fluid flow. The factory, and any or all of its components can be climate controlled, air ventilated and filtered, and/or heated. The heating can be accomplished with radiators, heat plumbing, natural gas heaters, electric heaters, diesel heaters, or other known equivalent devices. The heating can be accomplished by convection, radiation, conduction, or other known equivalent methods.

In one embodiment of the centralized power unit 103, the unit provides electrical power to all of the subunits within the well operations factory 100 via electrical connections. The centralized power unit 103 can be powered by liquid fuel, natural gas, or other equivalent fuel and may optionally be a cogeneration power unit. The unit may comprise a single trailer with subunits, each subunit with the ability to operate independently. The unit may also be operable to extend power to one or more outlying wellheads.

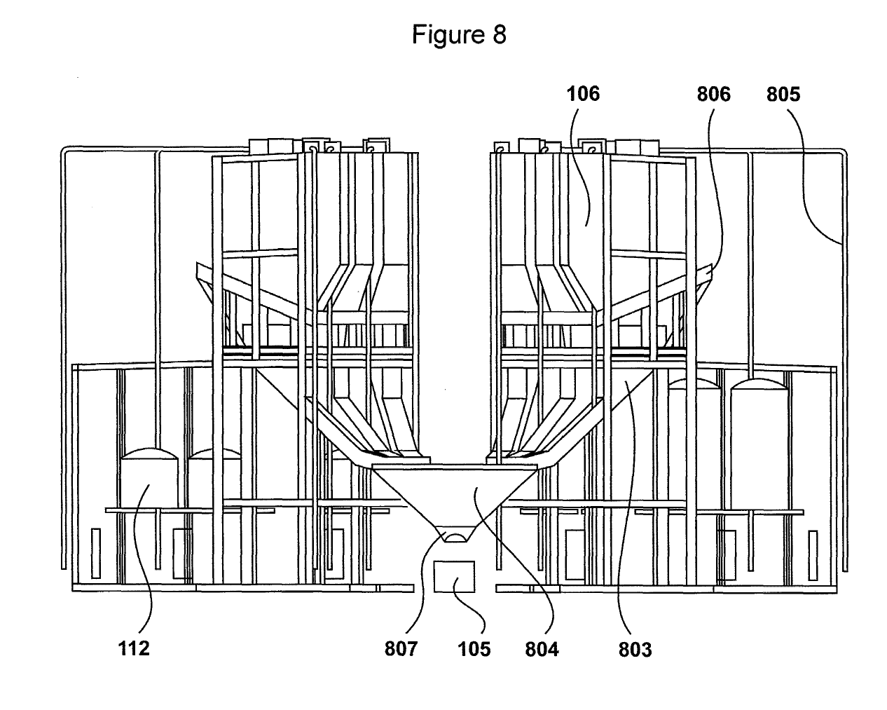

In one embodiment, the proppant storage system 106 is connected to the blending unit 105 and includes automatic valves and a set of tanks that contain proppant. Each tank can be monitored for level, material weight, and the rate at which proppant is being consumed. This information can be transmitted to a controller or control area. Each tank is capable of being filled pneumatically and can be emptied through a calibrated discharge chute by gravity. Gravity can be the substantial means of delivering proppant from the proppant tank. The tanks may also be agitated in the event of clogging or unbalanced flow. The proppant tanks can contain a controlled, calibrated orifice. Each tank's level, material weight, and calibrated orifice can be used to monitor and control the amount of desired proppant delivered to the blending unit. For instance, each tank's orifice can be adjusted to release proppant at faster or slower rates depending upon the needs of the formation and to adjust for the flow rates measured by the change in weight of the tank. Each proppant tank can contain its own air ventilation and filtering. In reference to FIG. 8, the tanks 106 can be arranged around each blending unit 105 within the enclosure, with each tank's discharge chute 803 located above the blending unit 105. The discharge chute can be connected to a surge hopper 804. In one embodiment, proppant is released from the proppant storage unit 106 through a controllable gate in the unit. When the gate is open, proppant travels from the proppant storage unit into the discharge chute 803. The discharge chute releases the proppant into the surge hopper. In this embodiment, the surge hopper contains a controlled, calibrated orifice or aperture 807 that releases proppant from the surge hopper at a desired rate. The amount of proppant in the surge hopper is maintained at a substantially constant level. Each tank can be connected to a pneumatic refill line 805. The tanks' weight can be measured by a measurement lattice 806 or by weight sensors or scales. The weight of the tanks can be used to determine how much proppant is being used during a well stimulation operation, how much total proppant was used at the completion of a well stimulation operation, and how much proppant remains in the storage unit at any given time. Tanks may be added to or removed from the storage system as needed. Empty storage tanks may be in the process of being filled by proppant at the same time full or partially full tanks are being used, allowing for continuous operation. The tanks can be arranged around a calibrated v-belt conveyor. In addition, a resin-coated proppant may be used by the addition of a mechanical proppant coating system. The coating system may be a Muller System.

In one embodiment, the chemical storage system 112 is connected to the blending unit and can include tanks for breakers, gel additives, crosslinkers, and liquid gel concentrate. The tanks can have level control systems such as a wireless hydrostatic pressure system and may be insulated and heated. Pressurized tanks may be used to provide positive pressure displacement to move chemicals, and some tanks may be agitated and circulated. The chemical storage system can continuously meter chemicals through the use of additive pumps which are able to meter chemical solutions to the blending unit 105 at specified rates as determined by the required final concentrations and the pump rates of the main treatment fluid from the blending unit. The chemical storage tanks can include weight sensors that can continuously monitor the weight of the tanks and determine the quantity of chemicals used by mass or weight in real-time, as the chemicals are being used to manufacture well treatment fluid. Chemical storage tanks can be pressurized using compressed air or nitrogen. They can also be pressurized using variable speed pumps using positive displacement to drive fluid flow. The quantities and rates of chemicals added to the main fluid stream are controlled by valve-metering control systems. The valve-metering can be magnetic mass or volumetric mass meters. In addition, chemical additives could be added to the main treatment fluid via aspiration (Venturi Effect). The rates that the chemical additives are aspirated into the main fluid stream can be controlled via adjustable, calibrated apertures located between the chemical storage tank and the main fluid stream. In the case of fracturing operations, the main fluid stream may be either the main fracture fluid being pumped or may be a slip stream off of a main fracture fluid stream. In one embodiment, the components of the chemical storage system are modularized allowing pumps, tanks, or blenders to be added or removed independently.

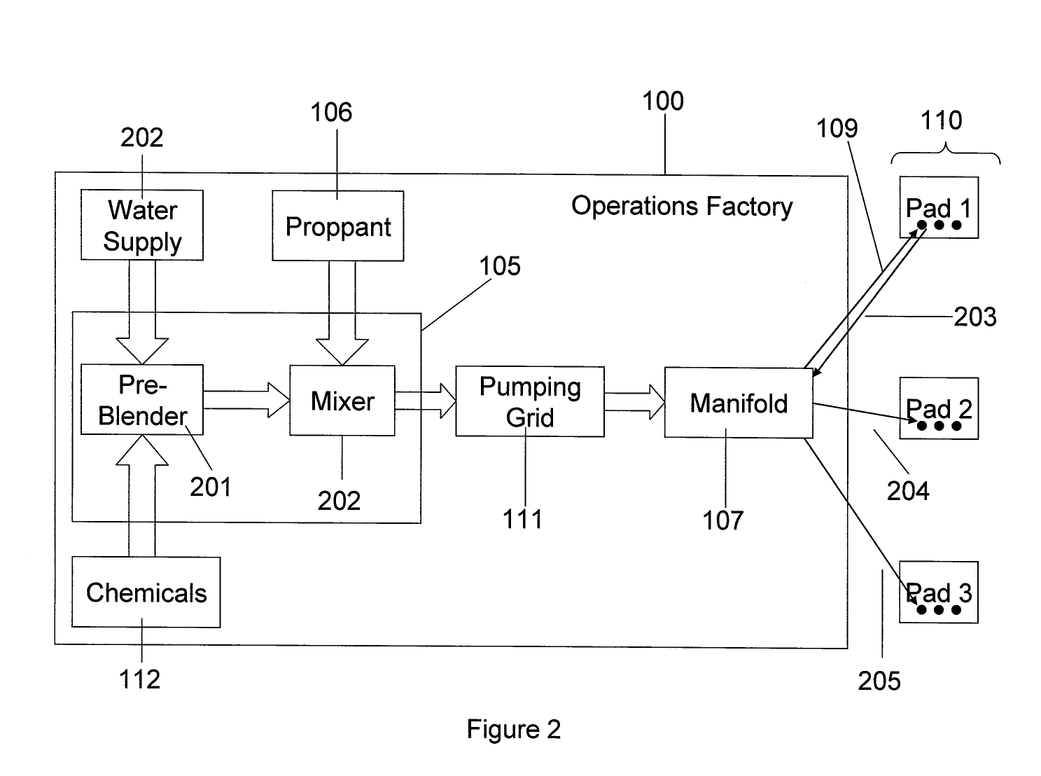

In reference to FIG. 2, in one embodiment, the blending unit 105 is connected to the chemical storage system 112, the proppant storage system 106, a water source 202, and a pumping grid 111 and may prepare a fracturing fluid, complete with proppant and chemical additives or modifiers, by mixing and blending fluids and chemicals at continuous rates according to the needs of a well formation. The blending unit 105 comprises a preblending unit 201 wherein water is fed from a water supply 202 and dry powder (guar) or liquid gel concentrate can be metered from a storage tank by way of a screw conveyor or pump into the preblender's fluid stream where it is mixed with water and blended with various chemical additives and modifiers provided by the chemical storage system 112. These chemicals may include crosslinkers, gelling agents, viscosity altering chemicals, PH buffers, modifiers, surfactants, breakers, and stabilizers. This mixture is fed into the blending unit's hydration device, which provides a first-in-first-out laminar flow. This now near fully hydrated fluid stream is blended in the mixer 202 of the blending unit 105 with proppant from the proppant storage system to create the final fracturing fluid. This process can be accomplished at downhole pump rates. The blending unit can modularized allowing its components to be easily replaced.

In one embodiment, the mixing apparatus is a modified Halliburton Growler mixer modified to blend proppant and chemical additives to the base fluid without destroying the base fluid properties but still providing ample energy for the blending of proppant into a near fully hydrated fracturing fluid. The final fluid can be directed to a pumping grid 111 and subsequently directed to a central manifold 107, which can connect and direct the fluid via connection 109, 204, or 205 to multiple wells 110 simultaneously. In one embodiment, the fracturing operations factory can comprise one or more blending units each coupled to one or more of the control units, proppant storage system, the chemical storage system, the pre-gel blending unit, a water supply, the power unit, and the pumping grid. Each blending unit can be used substantially simultaneously with any other blending unit and can be blending well treatment fluid of the same or different composition than any other blending unit.

In one embodiment, the blending unit does not comprise a pre-blending unit. Instead, the fracturing operations factory contains a separate pre-gel blending unit. The pre-gel blending unit is fed from a water supply and dry powder (guar) can be metered from a storage tank into the preblender's fluid stream where it is mixed with water and blended and can be subsequently transferred to the blending unit. The pre-gel blending unit can be modular, can also be enclosed in the factory, and can be connected to the central control system.

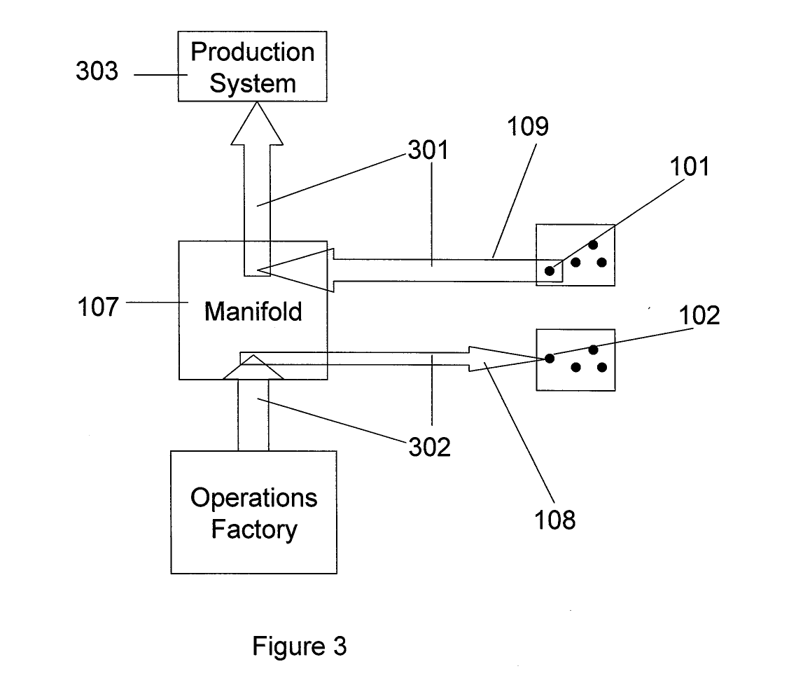

In one embodiment, the means for simultaneously flowing treatment fluid is a central manifold 107. The central manifold 107 is connected to the pumping grid 111 and is operable to flow stimulation fluid, for example, to multiple wells at different pads simultaneously. The stimulation fluid can comprise proppant, gelling agents, friction reducers, reactive fluid such as hydrochloric acid, and can be aqueous or hydrocarbon based. The manifold 107 is operable to treat simultaneously two separate wells, for example, as shown in FIG. 2 via connections 204 and 205. In this example, multiple wells can be fractured simultaneously, or a treatment fluid can be flowed simultaneously to multiple wells. The treatment fluid flowed can be of the same composition or different. These flows can be coordinated depending on a well's specific treatment needs. In addition, in reference to FIG. 3, the connection 109 between the central manifold 107 and a well location can be used in the opposite direction as shown in FIG. 2 to flow a production fluid, such as water or hydrocarbons, or return the well treatment fluid 301 from the well location to the manifold. From the central manifold 107, the production fluid can be directed to a production system 303 where it can be stored or processed or, in the case of the returning well treatment fluid, to a reclamation system that can allow components of returning fluid to be reused. The manifold is operable to receive production fluid or well treatment fluid from a first well location 101 while simultaneously flowing treatment fluid 302 using a second connection 108 to a second well location 102. The central manifold 107 is also operable to receive production fluid from both the first well location and the second well location simultaneously. In this embodiment, the first and second well locations can be at the same or different pads (as shown in FIG. 3). The manifold is also operable to extend multiple connections to a single well location. In reference to FIG. 2, in one embodiment, two connections are extended from the manifold to a single well location. One connection 109 may be used to deliver well treatment fluid to the well location while the other connection 203 may be used to deliver production fluid or return well treatment fluid from the well location to the central manifold 107.

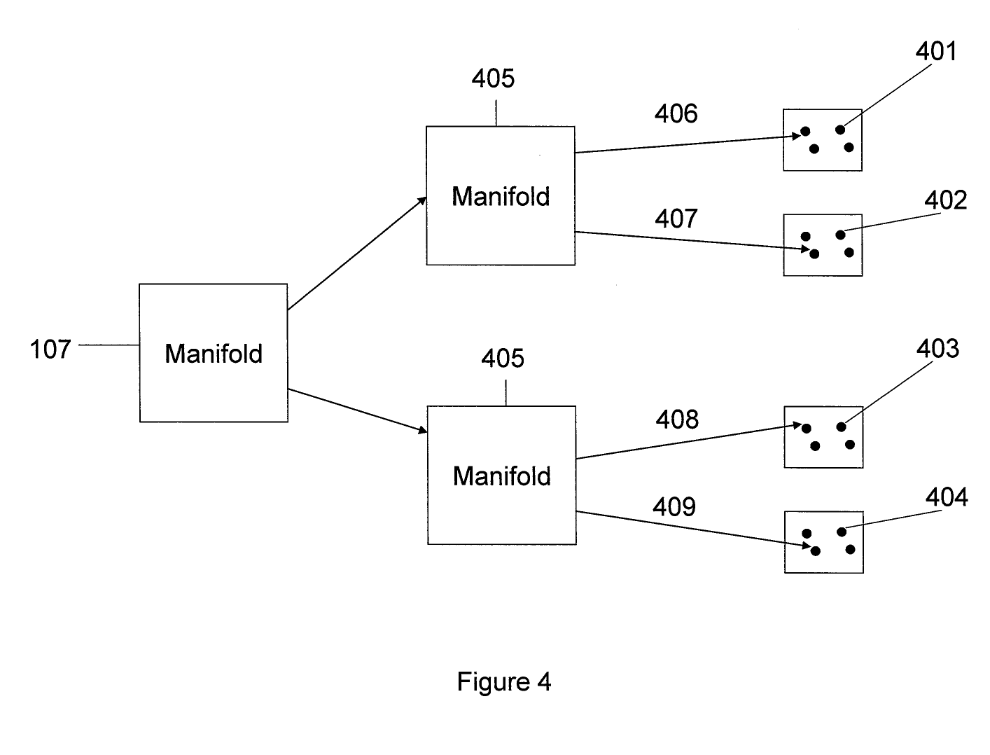

In reference to FIG. 4, in one embodiment, the central manifold 107 can be connected to one or more additional manifolds 405. The additional manifolds are operable to connect to multiple well locations 401-404 and deliver well treatment fluids and receive production fluids via connections 406-409, respectively, in the same way as the central manifold 107 described above in reference to FIGS. 2 and 3. The additional manifolds can be located at the well pads.

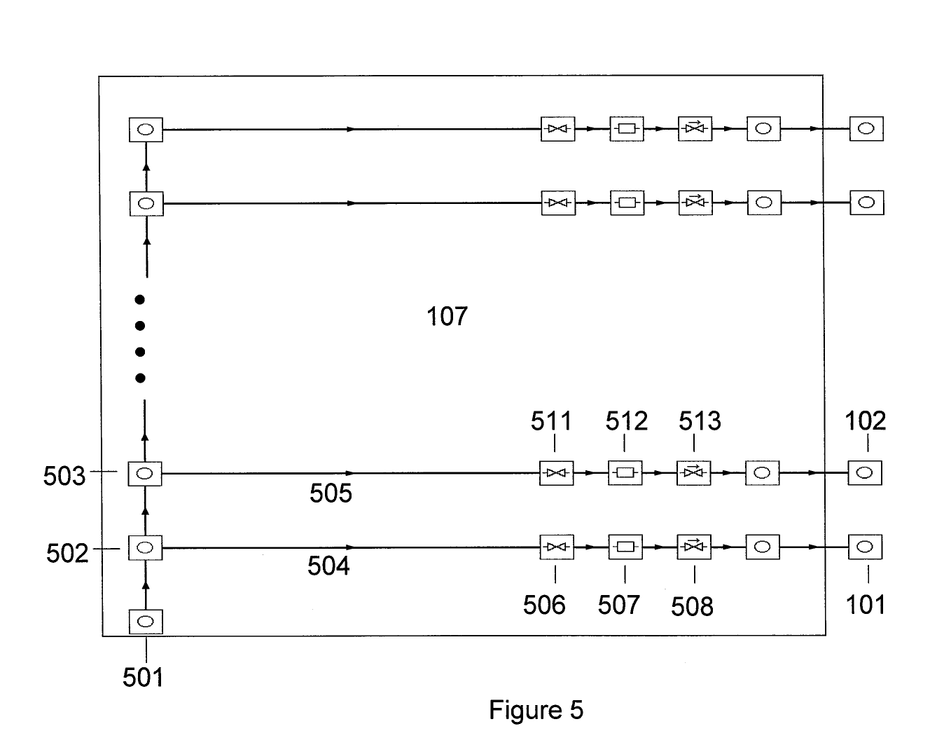

In reference to FIG. 5, in one embodiment, the central manifold has an input 501 that accepts pressurized stimulating fluid, fracturing fluid, or well treatment fluid from a pump truck or a pumping grid 111. The fluid flows into input 501 and through junctions 502 and 503 to lines 504 and 505. Line 504 contains a valve 506, a pressure sensor 507, and an additional valve 508. The line is connected to well head 101. Line 505 contains a valve 511, a pressure sensor 512, and an additional valve 513. These valves may be either plug valves or check valves and can be manually or electronically monitored and controlled. The pressure sensor may be a pressure transducer and may also be manually or electronically monitored or controlled. Line 504 is connected to well head 101 and line 505 is connected to well head 102. This configuration allows wells 101 and 102 to be stimulated individually and at a higher rate, by opening the valves along the line to the well to be treated while the valves along the other line are closed, or simultaneously at a lower rate, by opening the valves on both lines at the same time. As shown in FIG. 5, this architecture can be easily expanded to accommodate additional wells by the addition of junctions, lines, valves, and pressure sensors as illustrated. This architecture also allows monitoring the operations of the manifold and detecting leaks. By placing pressure sensors 507 and 512 between valves 506 and 508 and valves 511 and 513 respectively, the pressure of lines 504 and 505 can be readily determined during various phases of operation. For instance, when the manifold is configured to stimulate only well 101, valves 511 and 513 are closed. Pressure sensor 507 can detect the pressure within the active line 504, and pressure sensor 512 can be used to detect if there is any leakage, as it would be expected that the pressure in line 505 in this configuration would be minimal. In another embodiment, only a single valve is used along each of lines 504 and 505. This embodiment can be used to stimulate wells simultaneously or singly as well. Furthermore, as described in reference to FIG. 4, the manifold of this embodiment can also work in reverse and transfer fluid from the wellhead back through the manifold and to the central location. In this configuration, input 501 can be connected to a production system or reclamation system, for example, and the valves along the line connected to the wellhead in which it is desirable to recover fluid are open. The valves along the other lines may be open or closed depending on whether it is desirable to recover fluids from the wellheads connected to those lines. Production fluid or stimulation fluid can be returned from the wellhead to those systems respectively. This manifold can be located at the central location or at a remote pad.

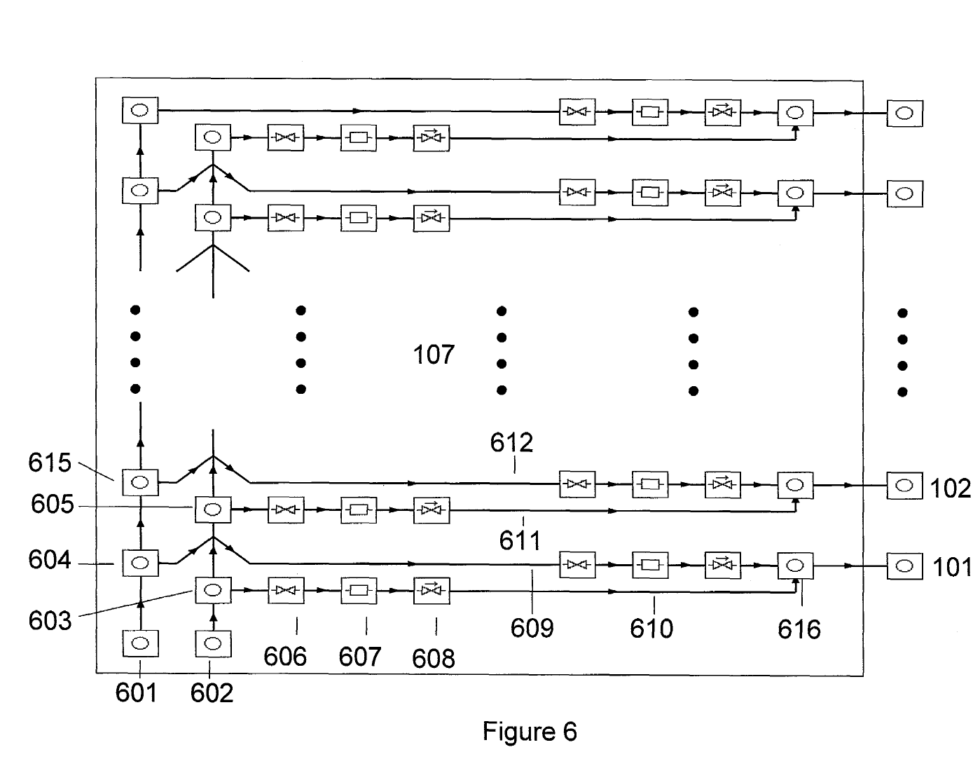

In reference to FIG. 6, in one embodiment, the central manifold contains two inputs 601 and 602 that accept pressurized stimulating fluid, fracturing fluid, or well treatment fluid from pump trucks or a pumping grid 111. Inputs 601 and 602 can accept fluid of different or the same compositions at similar or different pressures and rates. The fluid pumped through input 602 travels through junctions 603 and 605. The junctions are further connected to lines 610 and 611. The fluid pumped through input 601 travels through junctions 604 and 615. The junctions are further connected to lines 609 and 612. Lines 609, 610, 611, and 612 may each contain a valve 606, a pressure sensor 607, and an additional valve 608, or may contain only a single valve. These valves may be either plug valves or check valves and can be manually or electronically monitored and controlled. The pressure sensor may be a pressure transducer and may also be manually or electronically monitored or controlled. When, for example, the fluid from input 602 is desired to be delivered to well 101 only, the valves on line 610 are open and the valves on line 611 are closed. When the fluid from input 601 is desired to be delivered to well 101 only, the valves on line 609 are open and the valves on line 612 are closed. When it is desired that fluid from both inputs 601 and 602 are to be delivered to well 101 only, the valves on lines 609 and 610 are open and the valves on lines 611 and 612 are closed. Lines 609 and 610 are coupled to wellhead 101 through junction 616. When it is desired that fluid from input 602 be delivered to both wells 101 and 102 simultaneously, the valves on lines 610 and 611 are both open. Fluid from input 601 can be delivered to well 101 and fluid from input 602 can be delivered to well 102 simultaneously by closing the valves on lines 610 and 612 and opening the valves on lines 611 and 609. The delivery of fluid to well 102 works analogously. As shown in FIG. 6, the manifold can be easily expanded to include additional wells through additional junctions, lines, and valves. Furthermore, as described in reference to FIG. 4, the manifold of this embodiment can also work in reverse and transfer fluid from the wellhead back through the manifold and to the central location. In this configuration, either or both inputs 601 and 602 can be connected to a production system or reclamation system, for example, and the valves along the line connected to the wellhead in which it is desirable to recover fluid are open. The valves along the other lines may be open or closed depending on whether it is desirable to recover fluids from the wellheads connected to those lines. Production fluid or stimulation fluid can be returned from the wellhead to those systems respectively. This manifold can be located at the central location or at a remote pad.

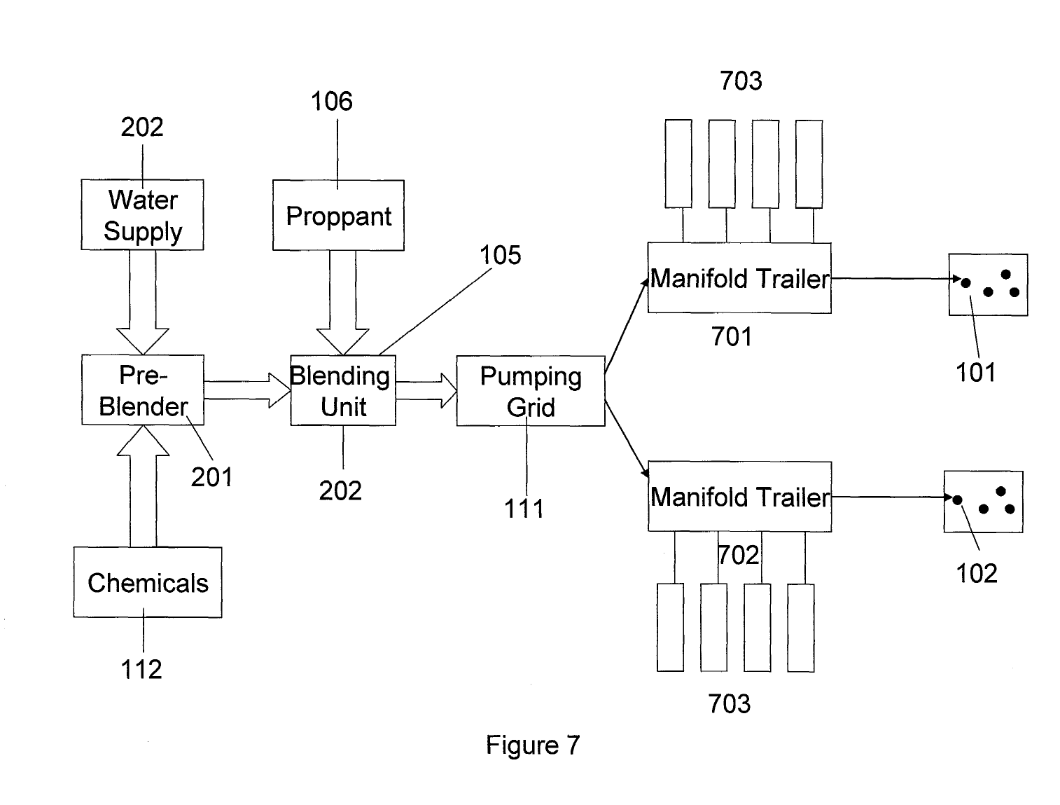

In reference to FIG. 7, in one embodiment, multiple manifold trailers 701 and 702 may be used at the central location where the stimulation fluid is manufactured and pressurized. The manifold trailers themselves are well known in the art. Each manifold trailer is connected to pressurized stimulating fluid through pump trucks 703 or a pumping grid 111. A line from each manifold trailer can connect directly to a well head to stimulate it directly, or it can further be connected to the manifolds described that are further connected to well locations.

In one embodiment of the pumping grid 111, the grid comprises one or more pumps that can be electric, gas, diesel, or natural gas powered. The grid can also contain spaces operable to receive equipment, such as pumps and other devices, modularized to fit within such spaces. The grid can be prewired and preplumbed and can contain lube oil and cooling capabilities. The grid is operable to accept connections to proppant storage and metering systems, chemical storage and metering systems, and blending units. The pumping grid can also have a crane that can assist in the replacement or movement of pumps, manifolds, or other equipment. A central manifold 107 can accept connections to wells and can be connected to the pumping grid. In one embodiment, the central manifold and pumping grid are operable to simultaneously treat both a first well head connected via a first connection and a second well head connected via a second connection with the stimulation fluid manufactured by the factory and connected to the pumping grid.

In some embodiments, the operations of the chemical storage system, proppant storage system, blending unit, pumping grid, power unit, and manifolds are controlled, coordinated, and monitored by a central control system. The central control system can be an electronic computer system capable of receiving analog or digital signals from sensors and capable of driving digital, analog, or other variety of controls of the various components in the fracturing operations factory. The control system can be located within the factory enclosure, if any, or it can be located at a remote location. The central control system may use all of the sensor data from all units and the drive signals from their individual subcontrollers to determine subsystem trajectories. For example, control over the manufacture, pumping, gelling, blending, and resin coating of proppant by the control system can be driven by desired product properties such as density, rate, viscosity, etc. Control can also be driven by external factors affecting the subunits such as dynamic or steady-state bottlenecks. Control can be exercised substantially simultaneously with both the determination of a desired product property, or with altering external conditions. For instance, once it is determined that a well treatment fluid with a specific density is desired, a well treatment fluid of the specific density can be manufactured virtually simultaneously by entering the desired density into the control system. The control system will substantially simultaneously cause the delivery of the proppant and chemical components comprising a well treatment fluid with the desired property to the blending unit where it can be immediately pumped to the desired well location. Well treatment fluids of different compositions can also be manufactured substantially simultaneously with one another and substantially simultaneously with the determination of desired product properties through the use and control of multiple blending units each connected to the control unit, proppant storage system, chemical storage system, water source, and power unit. The central control system can include such features as: (1) virtual inertia, whereby the rates of the subsystems (chemical, proppant, power, etc.) are coupled despite differing individual responses; (2) backward capacitance control, whereby the tub level controls cascade backward through the system; (3) volumetric observer, whereby sand rate errors are decoupled and proportional ration control is allowed without steady-state error. The central control system can also be used to monitor equipment health and status. Simultaneously with the manufacture of a well treatment fluid, the control system can report the quantity and rate usage of each component comprising the fluid. For instance, the rate or total amount of proppant, chemicals, water, or electricity consumed for a given well in an operation over any time period can be immediately reported both during and after the operation. This information can be coordinated with cost schedules or billing schedules to immediately compute and report incremental or total costs of operation.

The present invention can be used both for onshore and offshore operations using existing or specialized equipment or a combination of both. Such equipment can be modularized to expedite installation or replacement. The present invention may be enclosed in a permanent, semipermanent, or mobile structure.

As those of ordinary skill in the art will appreciate, the present invention can be adapted for multiple uses. By way of example only, multiple well sites may be treated, produced, or treated and produced sequentially or simultaneously from a single central location. The invention is capable of considerable additional modification, alteration, and equivalents in form and function, as will occur to those ordinarily skilled in the art having the benefit of this disclosure. The depicted and described embodiments of the invention are exemplary only, and are not exhaustive of the scope of the invention. Consequently, the invention is intended to be limited only by the spirit and scope of the appended claims.

What is claimed is:

1. A method for manufacturing well treatment fluid comprising:
delivering to a blending unit a desired rate of proppant by
weighing a proppant storage and metering unit storing the proppant; and
adjusting the size of a calibrated aperture on the proppant storage and metering unit;
delivering chemicals from a chemical storage and metering unit to the blending unit;
combining the proppant and chemicals in the blending unit; and
allowing the well treatment fluid to flow from the blending unit to a well location.

2. The method of claim 1 wherein proppant is delivered from the proppant storage and metering unit to the blending unit using substantially gravity.

3. The method of claim 1 further comprising:
delivering chemicals from a pre-gel blending unit to the blending unit.

4. The method of claim 1 wherein allowing the well treatment fluid to flow from the blending unit to the well location comprises
delivering the well treatment fluid to from the blending unit to a pumping grid; and
pumping the well treatment fluid to from the pumping grid to the well location.

5. The method of claim 4 wherein pumping the well treatment fluid from the pumping grid to the well location comprises
pumping the well treatment fluid from the pumping grid to a manifold; and
directing the well treatment fluid from the manifold to the well location.

6. A method for manufacturing well treatment fluid comprising:
delivering to a blending unit a desired rate of proppant by:
delivering proppant from a proppant storage and metering unit to a surge hopper;
maintaining a fixed level of proppant in a surge hopper; and
adjusting the size of a calibrated aperture on the surge hopper;
delivering chemicals from a chemical storage and metering unit to the blending unit;
combining the proppant and chemicals in the blending unit; and
allowing the well treatment fluid to flow from the blending unit to a well location.

7. The method of claim 6 wherein proppant is delivered from the proppant storage and metering unit to the surge hopper using substantially gravity.

8. The method of claim 6 further comprising:
delivering chemicals from a pre-gel blending unit to the blending unit.

9. A method for manufacturing well treatment fluid at a single location comprising:
(a) delivering to a first blending unit components of a first desired composition of a first well treatment fluid;
(b) blending the components of the first desired composition in the first blending unit to create the first well treatment fluid having the first desired composition;
(c) substantially simultaneously with step (a) delivering to a second blending unit components of a second desired composition of a second well treatment fluid;
(d) blending the components of the second desired composition in the second blending unit to create the second well treatment fluid having the second desired composition;
(e) allowing the first well treatment fluid to flow from the first blending unit to a first well location; and
(f) allowing the second well treatment fluid to flow from the second blending unit to a second well location.

10. The method of claim 9 wherein the first well treatment fluid comprises a compound selected from the group consisting of proppant, liquid additives, dry additives, fluid modifiers, and combinations thereof.

11. The method of claim 9 wherein the second well treatment fluid comprises a compound selected from the group consisting of proppant, liquid additives, dry additives, fluid modifiers, and combinations thereof.

12. The method of claim 9 further comprising
substantially simultaneously with steps (a) and (c) monitoring a quantity of the components delivered to the blending units.

13. A method for determining the usage of dry components during the manufacture of well treatment fluid comprising:
(a) delivering dry components to a blending unit; and
(b) substantially simultaneously with step (a) measuring the quantity of dry components delivered to the blending unit;
wherein the well treatment fluid flows from the blending unit to a well location.

14. The method of claim 13 wherein the dry components comprise a compound selected from the group consisting of proppant, dry additives, dry fluid modifiers, and combinations thereof.

15. A method for determining the usage of dry components in a storage unit during the manufacture of well treatment fluid comprising:
(a) delivering dry components to a blending unit; and
(b) substantially simultaneously with step (a) measuring the quantity of dry components remaining in the storage unit;
wherein the well treatment fluid flows from the blending unit to a well location.

16. The method of claim 15 wherein the dry components comprise a compound selected from the group consisting of proppant, dry additives, dry fluid modifiers, and combinations thereof.

17. A method for determining the usage of well treatment fluid components during the manufacture of well treatment fluid comprising:
(a) delivering a component of a well treatment fluid stored in a container to a blending unit; and
(b) substantially simultaneously with (a) weighing the container storing the component delivered;
wherein the well treatment fluid flows from the blending unit to a well location.

18. The method of claim 17 wherein the component comprises a compound selected from the group consisting of proppant, liquid additives, dry additives, fluid modifiers, and combinations thereof.

19. A method for billing for well stimulation services comprising:
substantially simultaneously with the completion of a well stimulation treatment, relating the quantity of a well treatment component delivered to a well with a cost schedule to determine the cost of the component.
